(19) United States
(12) Patent Application Publication
(10) Pub. No.: US 2025/0122780 A1
(43) Pub. Date: Apr. 17, 2025

(54) SYSTEMS AND METHODS FOR SEQUESTERING ALKALINE CARBONATES WITH CAPTURED CO2

(71) Applicant: Capture6 Corp., Berkeley, CA (US)

(72) Inventors: Luke Shors, Rotorua (NZ); Jeanine Ash, Seattle, WA (US); Alishan Salim, Spring, TX (US); David Sheh, Oakland, CA (US); Rahul Surana, Fremont, CA (US)

(21) Appl. No.: 18/919,246

(22) Filed: Oct. 17, 2024

Related U.S. Application Data
(60) Provisional application No. 63/590,964, filed on Oct. 17, 2023.

(51) Int. Cl. E21B 41/00

(52) U.S. Cl. CPC E21B 41/0064

(57) ABSTRACT

A method for sequestering carbon dioxide (CO₂) includes receiving an alkaline fluid stream and receiving an acidic stream. The alkaline fluid stream and the acidic stream are produced by a direct air carbon capture process and the carbonate includes air-captured CO₂. The method also includes producing a pH balanced CO₂ stream by mixing the alkaline fluid stream with an acidic mixing portion comprising 0% up to 100% of the acidic stream, and storing the pH balanced CO₂ stream in a storage location. The storage location can include at least one of a subsurface location, on land, or in a water body. The storage location and the pH balanced CO₂ stream are configured to provide long-term storage of the air-captured CO₂.

### CROSS-REFERENCE TO RELATED APPLICATION(S)

This application claims the benefit under 35 U.S.C. § 119 (e) to U.S. Provisional Application 63/590,964, filed Oct. 17, 2023, and entitled “APPARATUS, SYSTEMS, AND METHODS FOR SEQUESTRATION OF ALKALINE CARBONATES, EMBEDDED WITH CAPTURED CO₂ AND NEUTRALIZED WITH ACID, IN SUBSURFACE LOCATIONS AND WATER BODIES ON LAND,” which is hereby incorporated herein by reference in its entirety.

### TECHNICAL FIELD

The disclosed technology generally relates to storing and sequestering carbon dioxide (CO₂), and more particularly relates to storing and sequestering CO₂ in subsurface locations and in water bodies on land.

### BACKGROUND

Assessments performed by the Intergovernmental Panel on Climate Change (IPCC) based on science-based climate modeling suggest society needs to perform up to 10 gigatons of annual removal and permanent storage of atmospheric CO₂ by 2050 to stay within the 1.5° C. warming threshold established under The Paris Agreement. This massive target for carbon removal is in addition to storage needed for carbon capture and sequestration (CCS). The scale of storage needs suggests a need for storage options that are inexpensive, appropriate for multiple carbon removal and/or capture technologies, not limited in scale, and geographically diverse to support decarbonization globally.

Current practices for long-term CO₂ storage through subsurface injection involve injecting supercritical CO₂, seltzer, or gaseous CO₂. Supercritical CO₂ is created by the temperature and pressure manipulation of a concentrated stream of CO₂, resulting in CO₂ that behaves like a gas but has a fluid-like density. Depending on circumstances, supercritical CO₂ injection can be favored over injection of gaseous CO₂ due to its density allowing for greater storage of CO₂ per volume.

Injection of gaseous or supercritical CO₂ may occur in porous geological reservoirs (e.g., deep saline aquifers and depleted petroleum fields) below impermeable barriers. Gaseous or supercritical CO₂ is more buoyant than formation fluids and can rise upwards where there is permeability in the rock. For durable storage to occur, CO₂ must be trapped beneath a structural barrier (e.g., caprock), dissolved into formation water to increase its density, or held in pore space by capillary forces. In all cases, the risk for storage reversals remains high until the rate-limiting step of CO₂ entering the dissolved phase is complete, which can take up to 103 years. For this reason, a very thorough reservoir assessment is necessary prior to injecting gaseous or supercritical CO₂. An alternative to this methodology is the formation of seltzer at the surface prior to injection. Given the appropriate reservoir conditions, completely dissolved CO₂ is denser than formation brine, so it will sink within the reservoir and therefore not migrate upwards risking re-release. This type of CO₂ storage is referred to as solubility trapping.

In addition, dissolved CO₂ can be injected into reactive rocks and stored via mineral trapping. This type of CO₂ storage involves forming carbonate minerals by reacting dissolved inorganic carbon resulting from CO₂ dissolution (carbonic acid and bicarbonate) with mineral surfaces containing abundant divalent cations (e.g., mafic and ultramafic formations). The rate of mineralization can vary from 10-3 to 103 years depending on formation temperature, pressure, structure, and composition. Once minerals have crystallized, mineralization is durable on geologic timescales with among the lowest risk for reversal of all carbon storage mechanisms.

The kinetics of the mineralization reaction are a limiting factor when relying on this mechanism for storage. While preliminary findings in the industry estimate that the mineralization process can be 100% complete within two years, these finding involve geologically young formations with fresh mineral reactive surfaces and high geothermal gradients (due to tectonic and/or volcanic activity). Performing mineralization tests in rocks under these conditions ensures that carbonate mineralization proceeds under the best possible circumstances since fresh mineral surfaces and high temperatures increase the subsurface reaction rates, allowing for rapid mineralization.

Many continental and subseafloor mafic and ultramafic formations now being included as potential subsurface storage options are far from volcanic and tectonic activity and thus exhibit low geothermal gradients. If high geothermal gradients are determined to be necessary for sequestering carbon dioxide with a low risk of reversibility, then these potential storage options will have a higher risk of reversal or be infeasible due to low geothermal gradients. The risk of reversal is higher because longer mineralization periods increase the possibility of CO₂ degassing in the subsurface, rising to the surface, and re-releasing to the atmosphere. Additionally, these cooler and older formations may have already experienced some degree of carbonation as part of the natural geologic and hydrologic cycles, thus reducing the size of reactive surfaces.

Accordingly, there is a need in the art for improved injection materials, systems, and methods for storing CO₂ with a low risk of reversal.

### BRIEF SUMMARY

Implementations of the disclosed technology provide devices, systems, and methods for storing carbon dioxide. In various cases the storage is configured to provide long-term isolation from the atmosphere. Various implementations enable storage of CO₂ in subsurface locations by, for example, injecting dissolved alkaline carbonates. In various cases similar processes can be used for storing alkaline carbonates in water bodies on land, with or without using an acid to adjust pH.

Various aspects of the disclosed technology present one or more advantages over existing techniques, such as those involving injection of supercritical, seltzer or gaseous CO₂. For example, injecting alkaline fluids avoids the energy consumption and capital expense costs needed for compressors to perform the required pressure and temperature manipulation to turn gaseous CO₂ into a supercritical fluid, a dissolved fluid, or a compressed gas suitable for injection. In addition, injecting alkaline fluids can avoid potential loss of CO₂ at the surface due to mixing and injection operations for supercritical, seltzer or gaseous CO₂. Further, alkaline fluids (e.g., sodium carbonate (Na₂CO₃) and/or sodium bicarbonate (NaHCO₃)) will not degas CO₂ if exposed to the atmosphere. Accordingly, transporting captured and/or removed CO₂ does not require a dedicated pipeline and additional transportation options are possible. Injecting alkaline fluids into subsurface geological reservoirs (e.g. deep saline aquifers or depleted petroleum reservoirs) also increases the reliability of storage when compared to injecting supercritical, seltzer or gaseous CO₂, since the alkaline fluids will be denser and remain trapped below existing formation brines.

Among other advantages, injecting alkaline fluids can in various cases benefit from different regulatory requirements than supercritical, seltzer or gaseous CO₂. For example, alkaline fluid injection can in various cases access non-CO₂ specific well permitting. In some jurisdictions this type of permitting can be less arduous, time-consuming and expensive than CO₂-specific permitting such as the EPA Class VI permit required in the U.S. for supercritical, seltzer or gaseous CO₂.

In various implementations alkaline fluid injection can aid in managing reservoir pressure. In such cases, adding alkaline fluids can increase pressure and withdrawing saline fluids can decrease pressure. The withdrawn saline fluids can then be used as an input for direct air capture. As an example, adding alkaline fluids increases pore pressure and withdrawing saline fluid decreases pore pressure as needed for optimized operations and maximized storage capacity.

It can also be advantageous to inject alkaline fluids into mafic and ultramafic formations instead of supercritical, seltzer or gaseous CO₂ because the additive saturation of the high alkalinity injection fluids and the high alkalinity mafic and ultramafic formations results in effective, rapid, and durable storage of dissolved inorganic carbon.

In various implementations, electrochemical direct air capture or other carbon removal processes can be used to co-produce alkaline fluids along with other products, including hydrochloric acid (HCl) or other acids. These products can then be used to boost the productivity of injection wells by acting as a desealant in a process called acid stimulation. In various cases hydrochloric and/or other acids can also be used to boost reservoir performance by dissolving minerals in the rock in a process called matrix or fracture acidizing. Further, such acids can also be used to boost mineralization storage performance in mafic or ultramafic rocks by refreshing mineral surfaces and increasing reactive areas in cool formations or those with a degree of carbonation. Such products can also push the cone of mineralization away from the site of injection to keep fluid pathways clear for maximum storage potential. In addition, varying amounts of hydrochloric acid (HCl) or other acids can be safely and effectively injected into the subsurface for scalable disposal, with up to a 100% acid stream depending on subsurface geology.

In various implementations, HCl and/or other acid byproducts from direct air capture and other carbon removal processes can be consumed by injecting the acid(s) in combination with alkaline fluids (e.g., via co- or cyclical injection). Alkaline fluid injection thus provides a solution for disposing of quantities of HCl and other acids created during CO₂ removal which are currently a concern for scaling CO₂ removal. In addition, injecting alkaline fluids in combination with HCl or other acids instead of supercritical, seltzer or gaseous CO₂, makes it possible to PH balance the injection fluids. Such pH balancing can minimize reservoir geochemical interactions, maximize durable carbon storage, and meet regulatory requirements while also consuming the acid byproduct of a carbon removal process.

According to various implementations of the disclosed technology, alkaline carbonates embedded with captured CO₂ can also be stored in marine and terrestrial water bodies. Such an approach also provides multiple advantages including, among others, reducing the acidification of the ocean and similar water bodies by enhancing ocean alkalinity, increasing the water bodies' carbon capture capacity, providing readily available storage locations for capture technologies, neutralizing some of the alkalinity with acid without evolving CO₂ to balance pH, thus providing a solution for the disposal of acid created by capture technologies, and enhancing carbon capture capacity by dissolving alkaline minerals and other mafic/ultramafic rocks in acid before neutralizing the alkaline carbonates.

Various implementations of the disclosed technology include and/or follow on from a direct air capture process that creates at least two streams. In various cases one stream is a low-carbon acidic solution such as HCl. In various cases a second stream is the result of atmospheric CO₂ removal, such as an alkaline solution of Na₂CO₃ and NaHCO₃.

Implementations of the disclosed technology and described examples may include the use of hardware, a method or process, or computer software on a computer-accessible medium. Various implementations include a system of one or more computers that can be configured to perform particular operations or actions by virtue of having software, firmware, hardware, or a combination of them installed on the system that in operation causes or cause the system to perform the actions. As an example, various implementations may include one or more computers configured to carry out one or more parts of a method for sequestering CO₂ by controlling various hardware. One or more computer programs can be configured to perform particular operations or actions by virtue of including instructions that, when executed by data processing apparatus, cause the apparatus to perform the actions.

Several examples will now be discussed according to various aspects of the disclosed technology.

One aspect of the disclosed technology relates to a method for sequestering carbon dioxide. The method includes receiving an alkaline fluid stream comprising carbonate produced by a direct air carbon capture process, the carbonate comprising air-captured CO₂, and receiving an acidic stream produced by the direct air carbon capture process. The method further includes producing a PH balanced CO₂ stream by mixing the alkaline fluid stream with an acidic mixing portion comprising 0% up to 100% of the acidic stream and storing the pH balanced CO₂ stream in a storage location comprising at least one of a subsurface location, on land, or in a water body. In various cases the storage location and the pH balanced CO₂ stream provide long-term storage of the air-captured CO₂.

Implementations according to this aspect of the disclosure may include one or more of the following features. In some cases producing the pH balanced CO₂ stream comprises mixing the alkaline fluid stream with the acidic mixing portion in a subsurface chamber. In some cases producing the pH balanced CO₂ stream comprises mixing the alkaline fluid stream with the acidic mixing portion on the surface. In some cases producing the pH balanced CO₂ stream comprises simultaneously injecting the alkaline fluid stream and the acidic mixing portion into a subsurface chamber. In some cases producing the pH balanced CO₂ stream comprises alternately injecting the alkaline fluid stream and the acidic mixing portion into a subsurface chamber. In some cases the method further comprises alternately injecting the alkaline fluid stream and the acidic mixing portion in a low geothermal gradient thereby increasing carbonation of mineral rock to expand a mineralization area.

Various implementations may in some cases further include one or more of the following features. In some cases the method further comprises injecting the alkaline fluid stream and the acidic mixing portion or the pH balanced CO₂ stream into a subsurface mafic or ultramafic formation. In some cases the method further comprises mixing the acidic stream with an alkaline mineral before mixing the alkaline fluid stream with the acidic mixing portion. In some cases the method further comprises mixing a nanofiltration sludge produced by the direct air carbon capture process with the alkaline fluid stream, the acidic mixing portion, and an alkaline mineral, wherein the storage location is a water body on land. In some cases the storage location is a water body on land, and wherein the pH balanced CO₂ stream increases the alkalinity of the water body thereby increasing the carbon capture capacity of the water body.

In various implementations the method further comprises using the acidic stream to degas CO₂ from a water stream, capturing the degassed CO₂ with the alkaline fluid stream, thereby forming a bicarbonate stream, and storing the bicarbonate stream on land or in water. In some cases the method further comprises storing the bicarbonate stream in a water body, wherein the bicarbonate stream increases the alkalinity of the water body thereby increasing the carbon capture capacity of the water body. In some cases the method further comprises returning the degassed water stream to the sea, wherein the degassed water stream is capable of absorbing additional CO₂ from the atmosphere. In some cases the method further comprises mixing the degassed water stream with an alkaline mineral to increase the alkalinity of the degassed water stream before returning the degassed water stream to the sea.

Another general aspect of the disclosed technology includes a method for sequestering carbon dioxide. The method comprises receiving an alkaline fluid stream comprising carbonate produced by a direct air carbon capture process, the carbonate comprising air-captured CO₂, receiving an acidic stream produced by the direct air carbon capture process, producing a pH balanced CO₂ stream by mixing the alkaline fluid stream with an acidic mixing portion comprising 0% up to 100% of the acidic stream, and injecting the alkaline fluid stream and the acidic mixing portion into a subsurface storage location comprising a mafic or ultramafic formation. In various cases the storage location and the pH balanced CO₂ stream provide long-term storage of the air-captured CO₂.

Implementations according to this aspect may include one or more of the following features. In some cases the method further comprises mixing the alkaline fluid stream and the acidic mixing portion before injecting into the subsurface storage location. In some cases the method further comprises simultaneously injecting and mixing the alkaline fluid stream and the acidic mixing portion into the subsurface storage location to produce the pH balanced CO₂ stream. In some cases the method further comprises simultaneously injecting the alkaline fluid stream and the acidic mixing portion at a fluid pressure to create seltzer at the location of the injection or during the injection. In some cases the method further comprises dissolving an alkaline material in the acidic stream prior to mixing the alkaline fluid stream with the acidic mixing portion. In some cases the method further comprises mixing olivine with the acidic stream to produce an alkaline chloride solution and mixing the alkaline chloride solution with the alkaline fluid stream.

Several additional examples will now be discussed according to various aspects.

In Example 1, an acidic stream and an alkaline stream in a CO₂ removal process yielding an acid and an alkaline solution are injected into mafic and/or ultramafic formations in a repeating dual-stage loop with a first stage and a second stage. In the first stage of the loop, the injection of acid increases permeability and mineral-reactive surface; in the second stage of the loop, the alkaline fluids are injected to facilitate rapid mineralization and long-term carbon storage. In various cases this alternating injection approach reduces risk of reversal and unlocks additional suitable reactive rocks, such as those in low geothermal gradient and/or partially carbonated systems, via the acid's ability to increase mineral reactive surfaces. In various implementations, two continuous or simultaneous injections are mixed in a subsurface chamber. In various cases alkaline and acid streams are mixed on the surface, while avoiding any evolution of CO₂, and then injected as a single stream. In various implementations, other similar forms of mixing and injection can be used.

In Example 2, the alkaline stream alone of a CO₂ removal process can be injected into geological reservoirs (e.g., deep saline aquifers or depleted petroleum fields) where the alkaline fluid density is greater than the formation fluid density, allowing for gravity separation of the alkaline fluids for durable subsurface carbon storage.

In Example 3, the method in Example 2 in which the alkaline stream of a CO₂ removal process can be mixed at the surface with the concentrated or dilute acid stream of a CO₂ removal process in such a ratio to pH balance the alkaline stream without evolving gaseous CO₂ while maintaining, increasing or decreasing as necessary the density of the alkaline stream for injection into a geological reservoir or mafic/ultramafic formation.

In Example 4, the method in Example 3 in which the alkaline byproduct or the PH-balanced alkaline byproduct is injected into geological reservoirs containing deep saline aquifers to both durably store carbon in the subsurface while also aiding in pressure and flow management for reservoirs in which a carbon dioxide removal process is pumping the saline fluid to utilize it as the input for a carbon dioxide removal process.

In Example 5, the method of Example 1 in which both the alkaline and acidic streams in a CO₂ removal process can be injected simultaneously while held at an appropriate pressure to create seltzer at the point of or during injection into mafic and/or ultramafic formations and/or geological reservoirs to either facilitate mineralization in mafic and/or ultramafic formations or to be stored as dissolved CO₂ in appropriate geological reservoirs to facilitate durable carbon storage in the subsurface.

In Example 6, the method of Example 5 in which the alkaline stream alone can be injected into mafic or ultramafic formations to facilitate rapid subsurface mineralization and durable carbon storage.

In Example 7, the method of Example 1 in which various alkaline effluents of the CO₂ removal processes (such as, among others, nanofiltration reject stream, sludge from chemical softening process) can be injected instead of alkaline carbonates along with the acidic streams of the CO₂ removal process to enable the disposal of the acid stream. The alkaline elements in the effluent can also enable additional carbon capture by forming alkaline carbonates either in subsurface locations or also in water bodies and on land.

In Example 8, the method of Example 1 in which additional alkaline materials such as mafic and ultramafic rocks including olivine or sedimentary materials like lime can be dissolved in the acidic stream and then added to the alkaline carbonates to increase the amount of acid that is injected or mixed without the evolution of CO₂. The dissolution of alkaline minerals in acid increases the pH thereby allowing large volumes of resulting acidic stream to be used in the neutralization of the alkaline carbonate stream. Furthermore, the alkaline minerals added can increase the CO₂ absorption capacity of the resultant liquid.

In Example 9, the method of Example 8 in which olivine, which is rich in magnesium, is mixed with dilute or concentrated hydrochloric acid from the CO₂ removal process at room temperatures and pressures or elevated temperatures and pressures to form an alkaline chloride solution, such as magnesium chloride, which is acidic but has higher pH than hydrochloric acid. The alkaline chloride solution is then mixed with sodium carbonate solution from the CO₂ removal process to neutralize and store the resulting mixture, including the CO₂ captured in the sodium carbonate, in subsurface locations, in water bodies, or on land.

In Example 10, the method of Example 1 in which additional CO₂ captured from another process, either direct air capture or point source capture, could be dissolved in the alkaline carbonate stream to form alkaline bicarbonates. The alkaline bicarbonates, with or without the acid stream from the CO₂ removal process, can then be stored in subsurface locations, in water bodies, or on land ensuring no CO₂ is released as a result of the mixing and storage.

In Example 11, the method of Example 1 in which the CO₂ released to facilitate the mineralization in mafic and/or ultramafic formations is of better quality (e.g. low sulfur content) because the pathway-releasing CO₂ embedded in alkaline carbonates with acid from the CO₂ removal process—is a chemical synthesis resulting in impurities and contaminants removed from the brine (e.g., PFAS, nitrates, hexavalent chromium) staying dissolved in the liquid streams and not getting released with the evolution of CO₂.

In Example 12, the method of Example 11 in which the CO₂ evolution reaction is exothermic, aiding the mineralization in mafic and/or ultramafic formations. Furthermore, the exothermic reaction can aid in dissolving certain rock formations to enable durable CO₂ storage for the released CO₂ or the alkaline carbonate liquid that is injected and not neutralized with the acidic stream.

In Example 13, the method of Example 12 in which the alkaline carbonate solution is devoid of divalent ions such as Calcium and Magnesium, which aids in maintaining porosity and permeability by avoiding impairment by calcium and magnesium carbonate deposits.

In Example 14, the acid from the CO₂ removal process is used to remove CO₂ dissolved in water and utilized to convert the alkaline carbonates from the CO₂ removal process to alkaline bicarbonates. The alkaline bicarbonates are stored in subsurface locations or in water bodies or on land and the lean CO₂ water is mixed with alkaline mafic or ultramafic minerals, such as, among others, olivine, to increase the pH, and disposed in the water body. The alkaline rock that is added is dissolved in the acidic medium and aids in increasing the carbon capture capacity of the disposed stream.

In Example 15, the method in Example 14 in which the alkaline carbonate or the bicarbonate solution is mixed with the alkaline rock dissolved acidic stream to balance the pH before being released to subsurface locations or in water bodies or on land.

Example 16 includes a method for injection of alkaline fluids into subsurface geological reservoirs or formations of reactive (e.g., mafic and ultramafic) rocks to permanently and irreversibly store CO₂ captured from ambient air.

In Example 17, the method in Example 16 wherein the alkaline carbonates and acid streams are injected alternatingly in the low geothermal gradient subsurface to increase the carbonation of mineral rock and to expand the mineralization area.

In Example 18, the method in Example 17, wherein the carbonate and acid streams are injected simultaneously or pulsed or mixed in a structured or unstructured fashion mixing them either in the subsurface or on ground or in the path in-between.

In Example 19, the method in example 17, wherein the pH of the liquid is balanced such that CO₂ is not released upon injection and it stays sequestered in the liquid for long durations.

In Example 20, the method of Example 16, wherein the alkaline carbonate stream from the CO₂ removal system is dispersed in water bodies on land such that no CO₂ evolution occurs, thereby sequestering the captured CO₂.

In Example 21, the method of Example 20, wherein the pH of the liquid carbonate stream is balanced with the acid stream from the CO₂ removal system.

In Example 22, the method of Example 20, wherein the acid stream is mixed with alkaline minerals before mixing with the liquid carbonate stream for sequestration of captured CO₂.

In Example 23, the method of Example 20, wherein other effluent streams from the CO₂ removal system such as NF reject sludge are mixed with the alkaline carbonate stream and the acid stream along with alkaline minerals and dispersed in water bodies on land.

In Example 24, the method of Example 20, wherein the increased alkalinity of the water increases the carbon capture capacity of the water body through ocean alkalinity enhancement.

In Example 25, the method of Example 16, wherein the acid stream from the CO₂ removal system is used to degas CO₂ from the water such as seawater, which is in turn captured in the alkaline carbonate stream from the CO₂ removal system forming bicarbonates that can be stored on land or in water.

In Example 26, the method of Example 25, wherein the alkaline bicarbonates are dispersed in water, adding alkalinity to the water body, and increasing the carbon capture capacity through ocean alkalinity enhancement.

In Example 27, the method of Example 25, wherein the CO₂-lean seawater is returned to the sea capable of absorbing additional CO₂ from the atmosphere.

In Example 28, the method of Example 25, wherein the CO₂-lean seawater is mixed with alkaline minerals, increasing the alkalinity of the water and then returned to the sea capable of absorbing additional CO₂ from the atmosphere.

In Example 29, the method of Example 28, wherein the bicarbonate stream is mixed with the alkaline minerals dissolved in the CO₂-lean seawater before dispersing it to the sea, increasing the carbon capture capacity through ocean alkalinity enhancement.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a block diagram of a sequestration system and process according to an implementation.

FIG. 2 is a schematic illustration of a geochemical stage according to the sequestration system and process of FIG. 1 according to an implementation.

FIG. 3 is a schematic illustration of a geochemical stage according to the sequestration system and process of FIG. 1 according to an implementation.

FIG. 4 is a schematic illustration of a geochemical stage according to the sequestration system and process of FIG. 1 according to an implementation.

FIG. 5 is a schematic illustration of a system for trapping captured CO₂ according to an implementation.

FIG. 6 is a block diagram of a CO₂ sequestration system and process according to an implementation.

FIG. 7 is a process flow diagram depicting a system and corresponding process for mixing an alkaline carbonate stream with an output from a CO₂ removal system according to an implementation.

FIG. 8 is a block diagram of a CO₂ sequestration system according to an implementation.

FIG. 9 is a process flow diagram depicting a system and corresponding process for mixing an alkaline carbonate stream with an output from a CO₂ removal system and an alkaline mineral stream according to an implementation.

FIG. 10 depicts a carbon sequestration system and process according to an implementation.

FIG. 11 is a flow diagram of a system for capturing CO₂ from air and carrying out the carbon sequestration process of FIG. 10 according to an implementation.

FIG. 12 depicts a carbon sequestration system and process according to an implementation.

FIG. 13 is a flow diagram of a system for capturing CO₂ from air and carrying out the carbon sequestration process of FIG. 12 according to an implementation.

### DETAILED DESCRIPTION

Various examples and implementations disclosed or contemplated herein relate to storing carbon dioxide in conjunction with a carbon dioxide capture system and/or process. Such a system and/or process is alternatively referred to herein as a CO₂ removal process. In various implementations, CO₂ is stored in subsurface locations, as well as marine and terrestrial water bodies. Possible examples of subsurface storage locations include, but are not limited to, mafic and/or ultramafic rocks, sedimentary basins with deep saline aquifers, and depleted oil and gas reservoirs.

In various cases the carbon dioxide storage or sequestration is configured to be “long-term,” meaning that CO₂ will remain sequestered for a time period ranging from decades to thousands of years. In various implementations, the long-term carbon storage is configured to maintain sequestration of CO₂ for 1,000 years or more. In various cases, the long-term carbon storage is practically permanent and irreversible, similar to how other resources such as natural gas and oil are stored underground through natural, geologic mechanisms.

In various implementations, the CO₂ capture system is a direct air carbon capture that uses an electrochemical process to produce a hydroxide-rich stream from an input liquid such as, for example, saline. The hydroxide-rich stream is then used to capture CO₂ from air, thus producing an alkaline fluid such as a liquid carbonate fluid or solution. In addition to the alkaline fluid, the carbon capture system may also generate one or more by-products. One possible example includes a hydrogen-rich acid or acidic solution, such as hydrogen chloride.

Various CO₂ removal processes produce a stream of solid or liquid carbonates along with an acidic solution. In some cases the acidic solution is used to neutralize an alkaline carbonate solution, thus disposing of some or all of the acidic solution in addition to treating the alkaline carbonate fluid. In certain cases, alkaline minerals-such as mafic or ultramafic rock (e.g., olivine)—are dissolved in the acidic solution before mixing it with the alkaline carbonate solution from the CO₂ removal process. The resulting mixture provides storage for the captured CO₂ and also increases the potential for capturing additional CO₂ from, e.g., a body of water.

Additional embodiments and implementations disclosed or contemplated herein relate to methods and systems to replace or add on a bicarbonate solution or other effluents from the CO₂ removal process. Examples include a nanofiltration (NF) reject, sludge from the chemical softening process, and alkaline minerals to be neutralized with the acidic solution from the CO₂ removal process. In certain configurations, the acidic solution is first used to release dissolved CO₂ which is absorbed to form bicarbonates, and the CO₂-lean acidic solution is neutralized using alkaline minerals, with or without a bicarbonate solution, before dispersing it to water bodies on land.

As discussed above, various implementations of the disclosed technology include and/or follow on from a direct air carbon capture system and/or process. Examples of possible carbon capture systems/processes are disclosed in U.S. application Ser. No. 18/082,903, filed Dec. 16, 2022, and entitled “SYSTEMS AND METHODS FOR DIRECT AIR CARBON DIOXIDE CAPTURE,” and in U.S. application Ser. No. 18/480,779, filed Oct. 4, 2023, and entitled “SYSTEMS AND METHODS FOR INTEGRATED DIRECT AIR CARBON DIOXIDE CAPTURE AND DESALINATION MINERAL RECOVERY,” both of which are hereby incorporated by reference in their respective entireties.

Various implementations can make use of the technologies disclosed in other examples and aspects herein, such that the teachings contained herein all relate to variations on the implementations disclosed elsewhere herein. One of skill in the art would readily appreciate that in certain implementations, features or other aspects disclosed in any specific example detailed herein can be combined with additional features outlined in alternate examples, such that the instant disclosure contemplates combining various features for individual applications of the disclosed technology. In various cases the teachings of one or more implementations disclosed herein can apply and be used with other implementations disclosed herein, as well as with various examples discussed in U.S. application Ser. No. 18/082,903 and U.S. application Ser. No. 18/480,779 noted above.

As described herein, the disclosed technologies are often referred to broadly as a system and/or process, a sequestration system and/or process, or a carbon capture and sequestration system and/or process, though it is understood that this is for brevity and is in no way intended to be limiting to any specific modality.

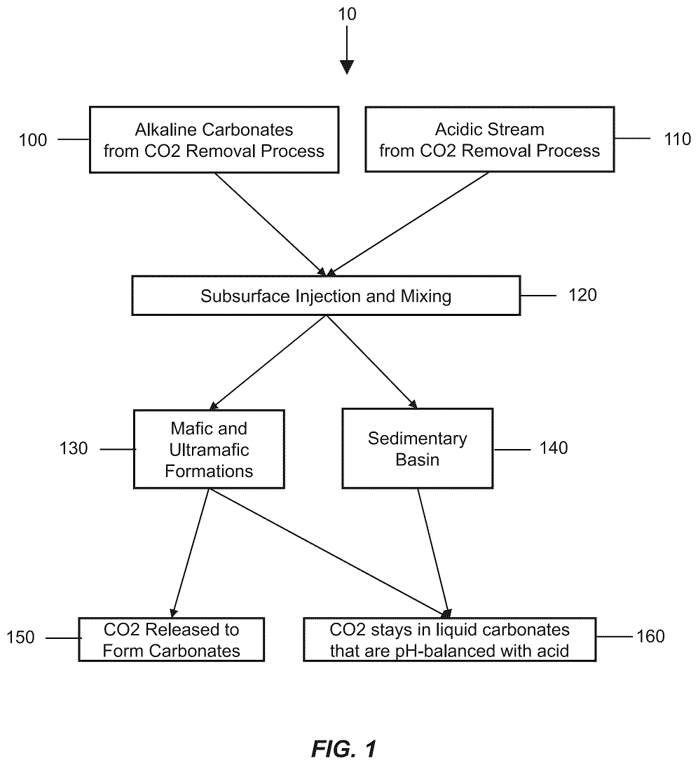

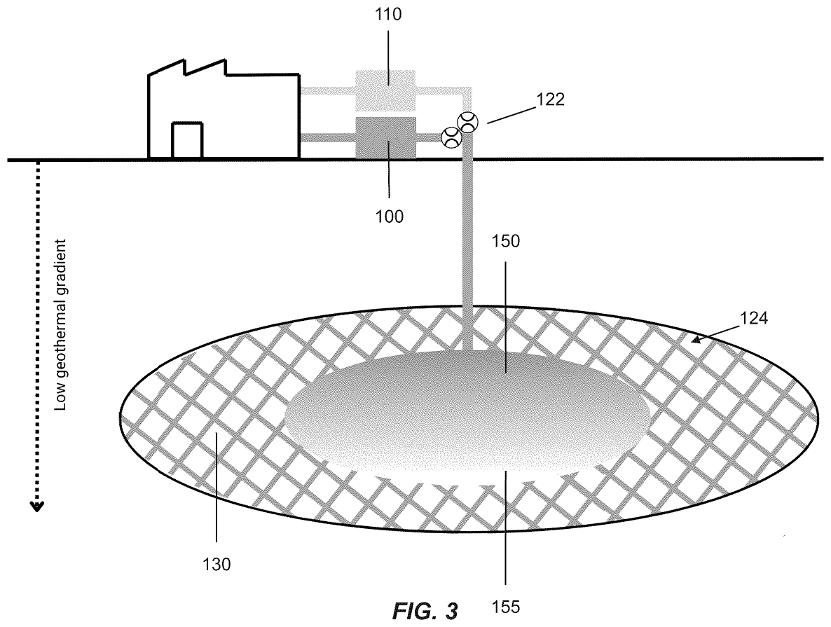

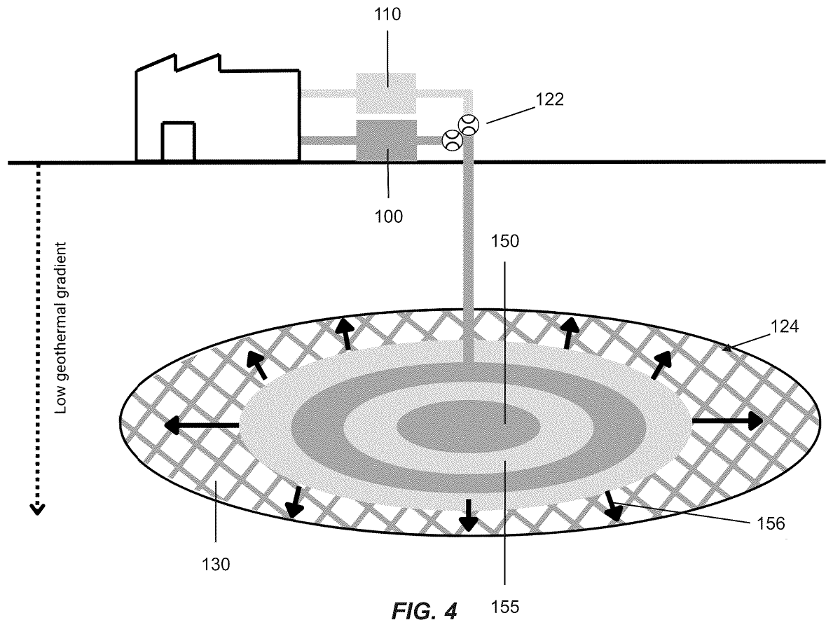

Various implementations of a sequestration system 10 relate to sequestering CO₂ through subsurface injection. Turning to the drawings, FIGS. 1, 2-4, and 5 depict examples of a system for the subsurface injection of alkaline carbonate and acidic solutions, from a CO₂ removal process, in mafic or ultramafic formations and/or geological reservoirs. In various cases CO₂ is either released to form various forms of carbonate depending on the rock formation or remains dissolved in liquid phase.

FIG. 1 is a block diagram of a sequestration system and process 10 according to various implementations. The system 10 involves the sequestration of CO₂ through subsurface injection of the alkaline carbonate solution 100 and acidic solution 110 from the CO₂ removal system. In various implementations the subsurface injection 120 includes a dual-mode injection into an underground chamber that alternates between the acid and the alkaline streams. In some cases the subsurface injection 120 includes the simultaneous mixing of the two streams in the underground chamber before it is released.

According to various implementations, the subsurface location includes mafic or ultramafic rock formations 130. In some cases the subsurface location includes one or more sedimentary basins 140. Examples of such basins include, but are not limited to, deep saline aquifers and depleted oil reservoirs. As depicted in FIG. 1, after injection and mixing, in various cases the CO₂ (e.g., in a mixture of alkaline fluids and acidic solution) is released and sequestered in the form of other mineral carbonates 150 based on the rock (e.g., mafic, ultramafic) formation or is sequestered in the liquid carbonates 160.

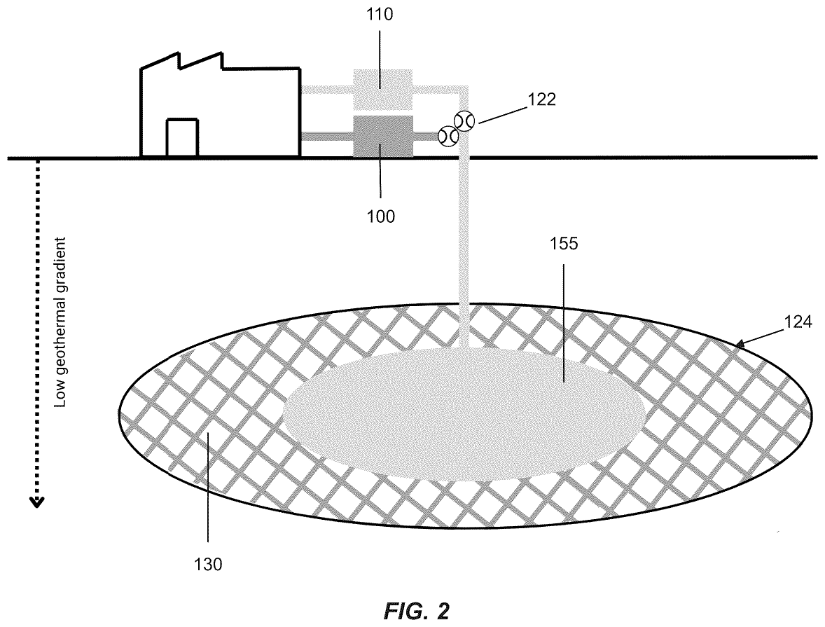

FIGS. 2-4 depict multiple geochemical stages in an example of the CO₂ sequestration process 10 of FIG. 1. According to the depicted implementation, acidic and alkaline carbonate solutions from a CO₂ removal system are injected using a 2-way switching valve 122 into a subsurface location with mafic and/or ultramafic rock formations 124. The acidic stream 110 reacts with the mafic and ultramafic rock 124 to expose alkaline minerals 130 (e.g., carbonated basalt pre-acid), thus enabling the carbonation reaction to form mineralized carbonates 150 using CO₂ captured from the atmosphere when the alkaline carbonate stream 100 is introduced. The 2-way switching valve 122 alternates between injecting the acidic stream 110 and the alkaline stream 100, thus enabling higher carbonation of the mafic and ultramafic rocks 124 by expanding the pore space and reactive surfaces 155 and expanding the cone of mineralization 156.

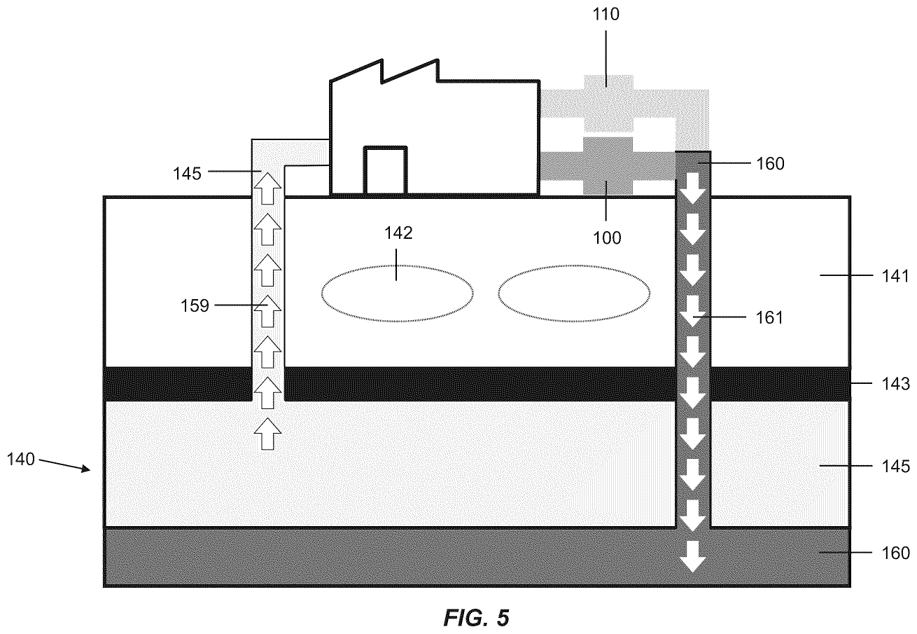

FIG. 5 depicts physical trapping of captured CO₂ in the form of alkaline carbonates in deep saline aquifers according to various implementations. In the illustrated example, the acidic stream 110 and the alkaline carbonate 100 solution stream from the CO₂ removal system are mixed aboveground (e.g., on the surface) to produce a pH balanced mixed CO₂ solution 160. In various cases the pH of the mixed solution 160 is balanced closer to that of a saline aquifer 145 to minimize or eliminate evolution of CO₂. In various implementations the acidic and alkaline streams 110, 100, respectively, can be mixed underground. Returning to FIG. 5, the mixed solution 160 is pumped into a sedimentary basin 140 below the sediment deposits 141, shallow groundwater 142, and an impermeable barrier 143 into a deep saline aquifer 145. The injected solution 160 with CO₂ dissolved in it has a higher density and sinks to the bottom of the aquifer 145. To ensure that the aquifer pressure remains stable, saline water that is lean in CO₂ can be pulled out of the aquifer 145 and used as input for the CO₂ removal process. The flow of the saline water 159 is upwards and in the opposite direction of the flow 161 of the injected acid and alkaline carbonate stream. The impermeable barrier 143 physically impedes the vertical migration of CO₂ in case it is released from the alkaline carbonates thus ensuring complete sequestration of the captured CO₂.

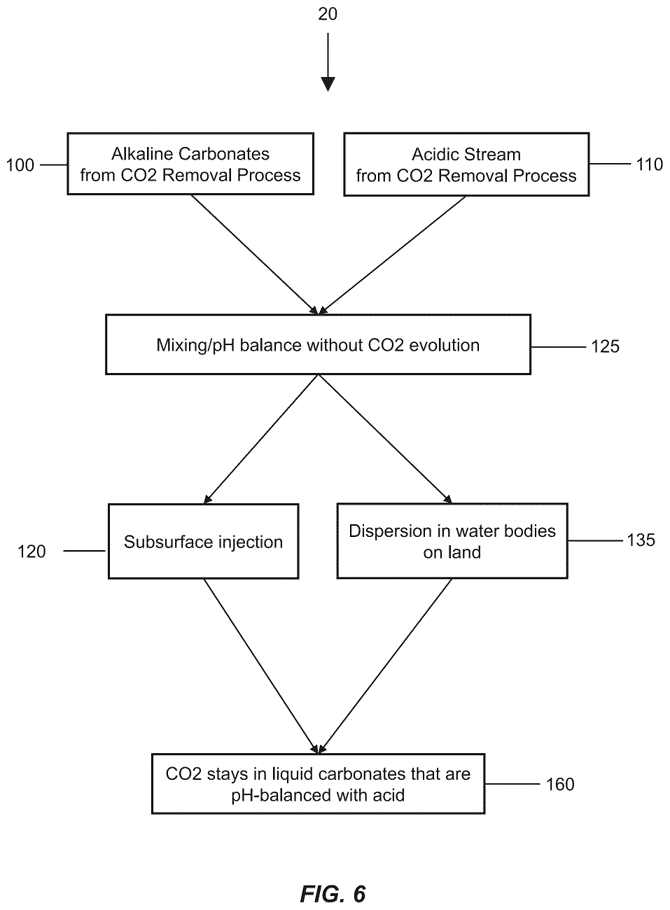

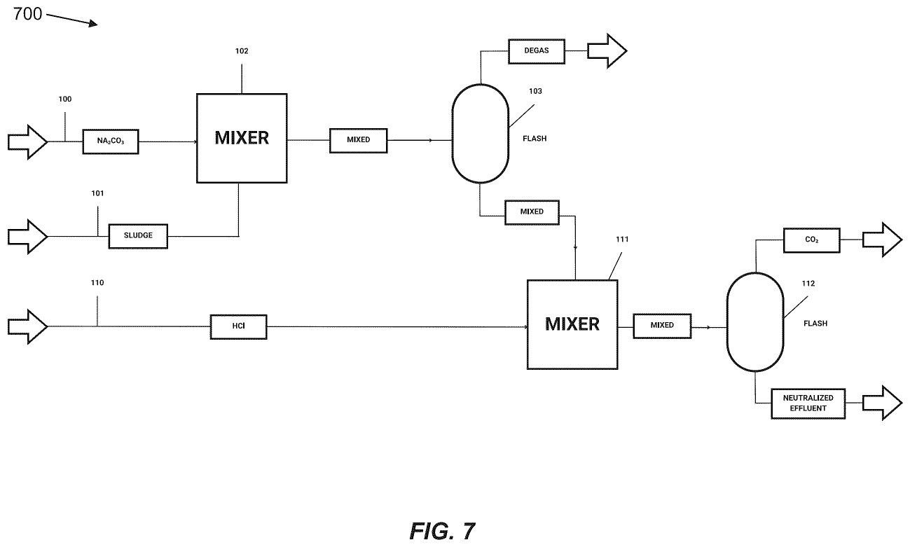

FIGS. 6 and 7 depict an example of a sequestration system and/or process in which alkaline carbonate and acidic solutions from a CO₂ removal process are mixed without the evolution of CO₂ and then injected in subsurface locations or in water bodies on land.

FIG. 6 depicts a block diagram of a sequestration system and/or process 20 according to various implementations. In the depicted example, alkaline carbonates 100 formed with a CO₂ removal system are stored or sequestered according to one of several optional methods. In various cases alkaline carbonate stream 100 is optionally mixed with the acid stream 110 to varying degrees as necessary to achieve pH balance or neutralization without evolving CO₂ 125. For example, in some cases the carbonate stream 100 may be mixed with anywhere from 0% of the acid stream 110 up to 100% of the acid stream 110 to achieve a pH balance. In some cases, the balanced mixture is dispersed in water bodies on land 135 and the captured CO₂ is sequestered in the liquid stream 160 while it increases the alkalinity of the water bodies to capture additional CO₂. In various implementations the balanced mixture is injected subsurface 120. In the event that some CO₂ is released, the underlying rock formation will facilitate carbonation, thus locking the captured CO₂ for long duration.

FIG. 7 is a process flow diagram depicting a system 700 and corresponding process for mixing an alkaline carbonate stream 100 with sludge 101 from a CO₂ removal system. As an example, in various cases the carbonate stream 100 includes sodium carbonate and the sludge 101 includes various hydroxides, carbonates, and/or other substances filtered by the CO₂ removal system. As shown in FIG. 7, the alkaline carbonates 100 and sludge 101 are mixed in a mixer 102 and vented in a vessel 103 to ensure none of the captured CO₂ is degassed. This stream is then, if needed, mixed with an acidic stream 110 from the CO₂ removal system in another mixer 111 and vented in a vessel 112 to ensure none of the captured CO₂ is degassed. According to various implementations, a processing system running modeling software can model the electrolyte concentrations of the acidic 110, alkali carbonate 100, and sludge 101 streams and evaluate if CO₂ is degassed due to the mixing of these streams. In various cases this method can ensure the balancing of the pH and sequestration of the CO₂ in the liquid stream so that can be stored in the subsurface or in water bodies on land.

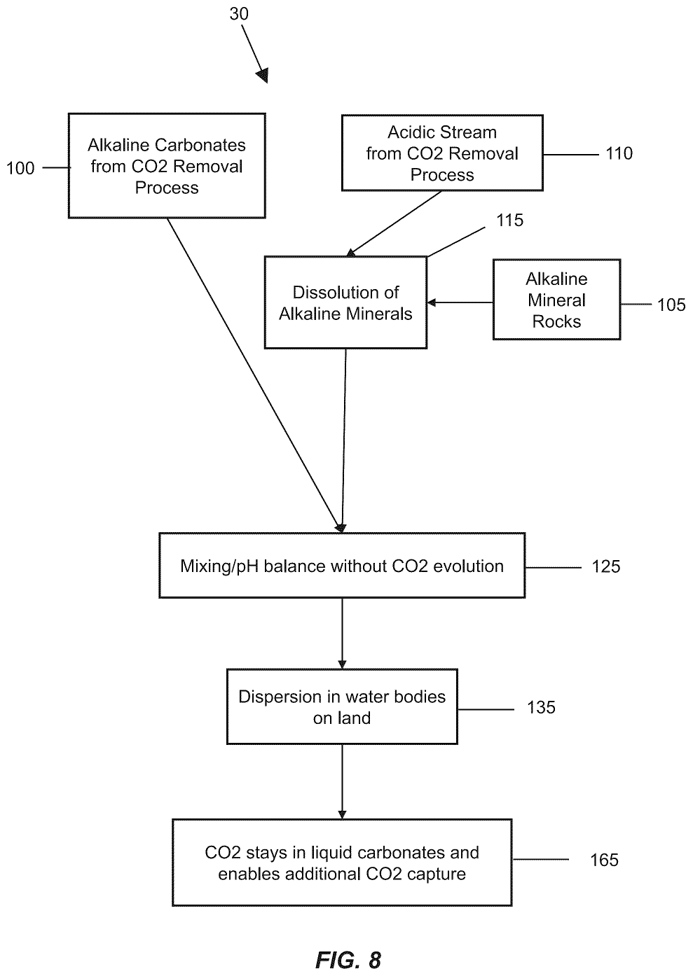

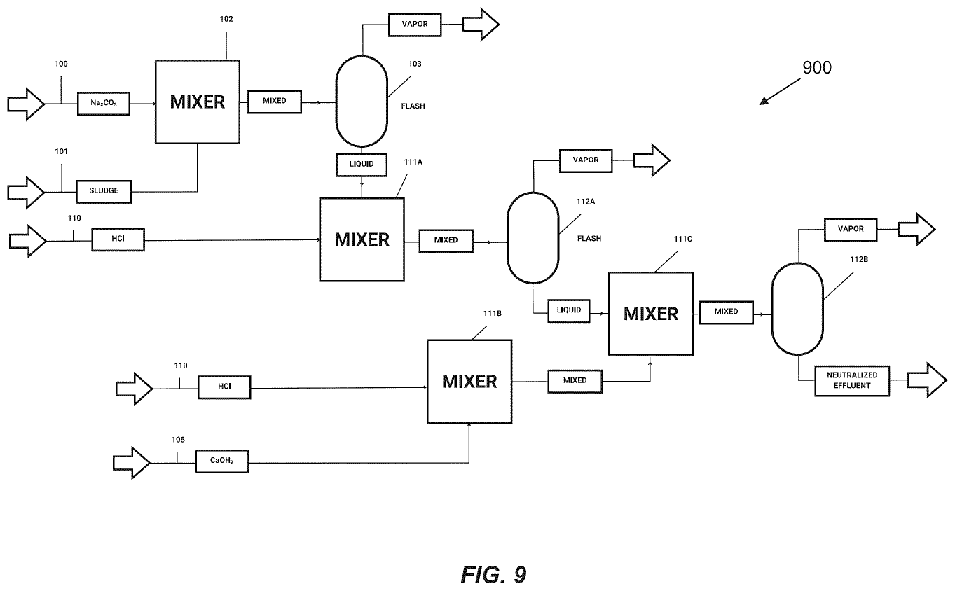

FIGS. 8 and 9 depict an example of a CO₂ sequestration system and process in which alkaline mineral rock is dissolved in an acidic solution from a CO₂ removal process. The resulting liquid is mixed with carbonates and dispersed in water bodies on land, thus storing the captured CO₂ and enabling additional CO₂ capture.

Turning to FIG. 8, an example of a CO₂ sequestration system 30 is depicted according to various implementations. In this example, alkaline mineral rocks 105 are mixed with the acid stream 110 from the CO₂ removal system. The mixture results in the dissolution 115 of the alkaline rock, thus increasing the solution's alkalinity and pH. This solution with dissolved alkaline minerals is then mixed with an alkaline carbonate stream 100 to form a liquid carbonate solution with a balanced pH while ensuring no CO₂ is released 125. The liquid carbonate solutions can be dispersed in water bodies on land 135 while simultaneously sequestering the CO₂ captured from the removal process and enabling additional CO₂ capture from the water bodies 165.

FIG. 9 is a process flow diagram depicting a system 900 and corresponding process, similar to FIG. 7, with the addition of an alkaline mineral stream 105, such as calcium hydroxide, mixed with the acid stream 110 from the CO₂ removal system to form alkaline chloride in a mixer 111B before further mixing with the liquid carbonate stream, as in FIG. 7, in mixer 111C. The resulting solution is settled in a vessel 112B and checked for any CO₂ degassing. In various implementations software modeling that incorporates the properties of the electrolyte solutions can determine that no CO₂ gas is released due to mixing of the alkaline carbonates, sludge, alkaline mineral, and the acid streams so that the resulting liquid stream can be dispersed in water bodies on land while simultaneously sequestering the captured CO₂.

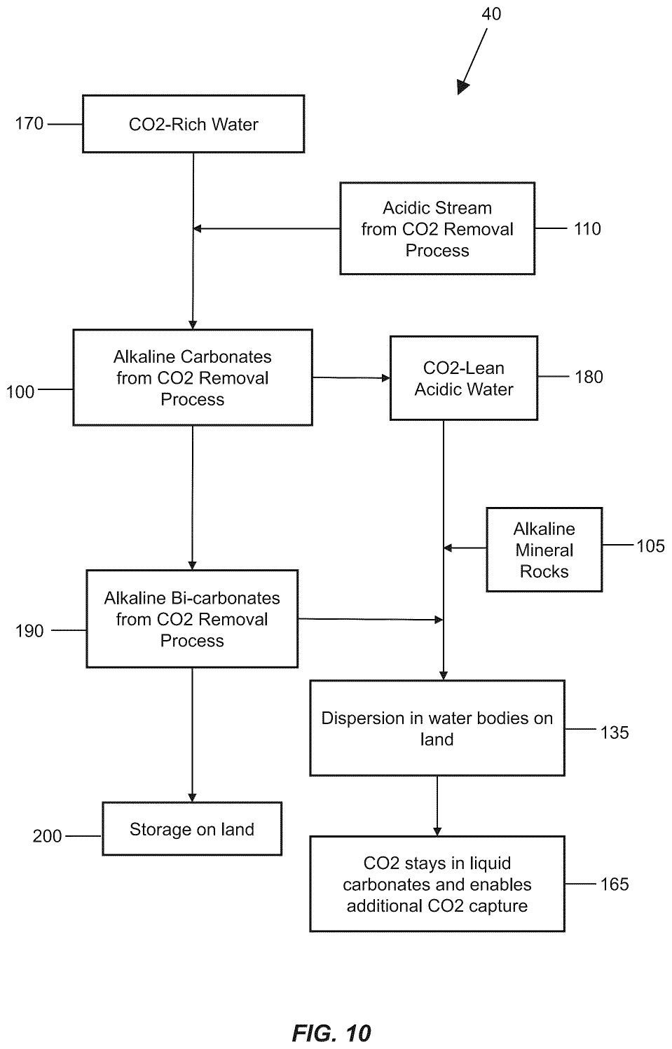

FIGS. 10, 11, 12, and 13 depict examples of CO₂ sequestration systems and processes in which an acidic solution from a CO₂ removal process is utilized to release CO₂ from water or CO₂ derived from an additional atmospheric air or concentrated CO₂ source. The CO₂ is captured in a carbonate solution from the CO₂ removal process to form bicarbonates. A CO₂ lean acidic solution is mixed with alkaline minerals, such as olivine, to neutralize the stream before sending it back to marine and terrestrial water bodies. In various cases the bicarbonate solution is either stored on land or mixed with the alkaline mineral rock acidic stream to further neutralize the stream before sending it back to water bodies on land.

FIG. 10 depicts a carbon sequestration system 40 according to various implementations in which CO₂-rich water 170, such as seawater, is mixed with the acid stream 110 from the CO₂ removal system to release CO₂ dissolved in the water 170. the released CO₂ is then mixed with the alkaline carbonate stream 100 from the CO₂ removal system to form alkaline bicarbonates 190, which can be stored on land 200 or dispersed in water bodies on land 135. In various cases the CO₂-lean acid water solution 180 is mixed with alkaline mineral rocks 105 and mixed with the alkaline bicarbonate solution 190 for pH balance before dispersing it in water bodies on land 135. The CO₂ captured from the air and the water stays in the liquid carbonate streams, thus sequestering the captured CO₂ for a long duration 165. In various cases the liquid solution also increases the alkalinity of the water bodies, allowing additional molecules of CO₂ from the air to be captured by water through ocean alkalinity enhancement.

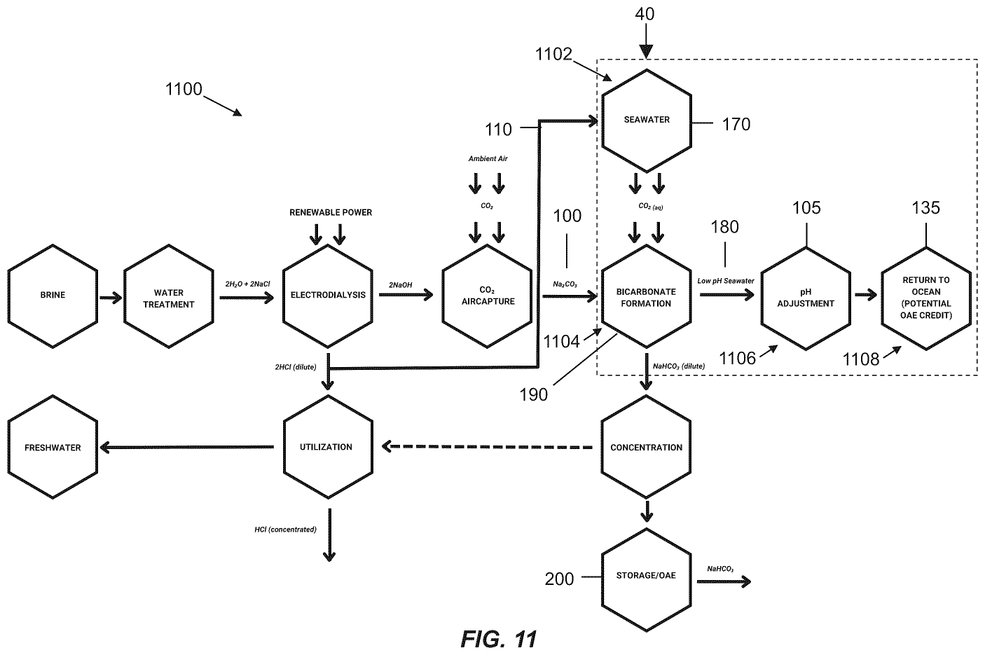

FIG. 11 is a flow diagram that depicts a system 1100 for capturing CO₂ from air and carrying out the carbon sequestration system and process 40 shown in FIG. 10 using the acidic and alkaline streams from the CO₂ removal system according to various implementations. A first step 1102 is mixing the acidic stream 110 from CO₂ removal system with seawater 170 to release the CO₂ that is dissolved in water. A second step 1104 is mixing the CO₂ released from the seawater with the alkaline carbonate stream 100 from the CO₂ removal system to form alkaline bicarbonates 190. The alkaline bicarbonates 190 can be concentrated and stored on land 200 or dispersed in water bodies on land 135 to increase alkalinity levels thereby increasing the CO₂ absorption capacity of the water bodies. In a third step 1106, the CO₂-lean seawater is mixed with alkaline rock 105, such as mafic/ultramafic rocks, to increase its pH and alkalinity before returning 1108 the solution back into the sea 135. The alkaline rock increases the alkalinity levels of the water, thereby increasing the CO₂ absorption capacity of the water body.

According to one possible example, carrying out the process 40 involves first adding HCl to the seawater to decrease the pH to about 5 or 6, at which aqueous CO₂ species predominate. Next, low pH seawater is flowed through stacks of gas-permeable hollow fiber membrane tubes (similar to air contactors) filled with Na₂CO₃, which is evolved from NaHCO₃ through contact with diffused CO₂. In the third step, low pH seawater is pH adjusted through alkalinization with mafic/ultramafic rocks. In the fourth step, CO₂ lean seawater with about a pH of 8.1 is returned to the ocean.

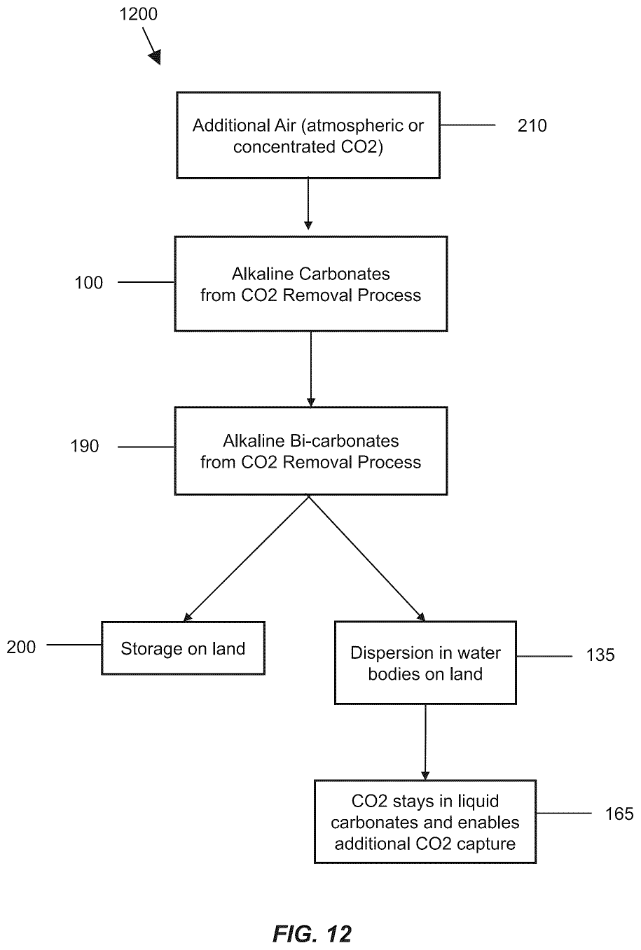

FIG. 12 depicts a carbon sequestration system 1200 similar to the system 40 of FIG. 10 according to various implementations. In this example, the system is slightly modified so that additional air 210 rather than CO₂-rich water 170 is mixed with the alkaline carbonate stream from the CO₂ removal system 100 to form alkaline bicarbonates 190, which can be stored on land 200 or dispersed in water bodies on land 135. The captured CO₂ from air and water stays in the liquid carbonate streams sequestering the captured CO₂ for a long duration 165. The liquid solution, also, in certain cases increases the alkalinity allowing additional molecules of CO₂ from the air to be captured by water through ocean alkalinity enhancement.

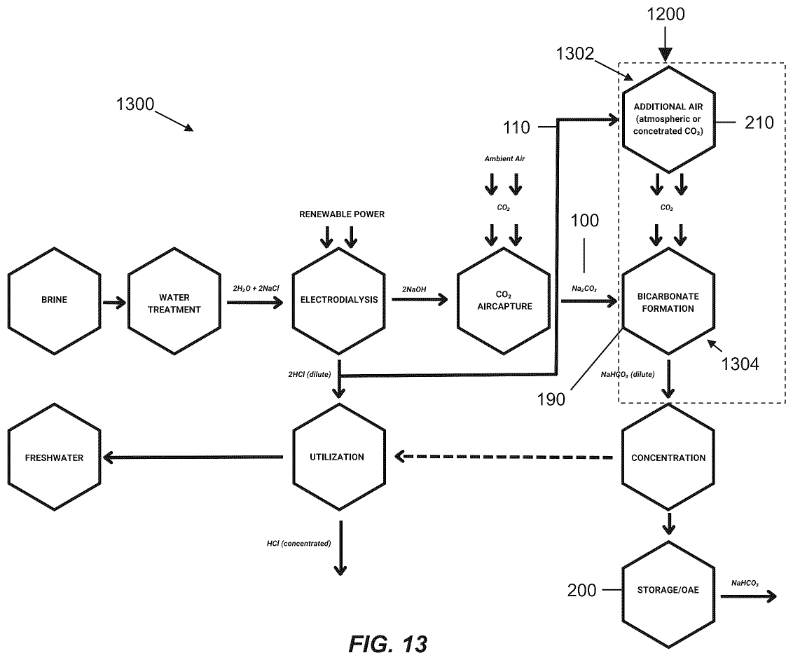

FIG. 13 is a flow diagram that depicts a system 1300 for capturing CO₂ from air and carrying out the implementation of the carbon sequestration system 1200 of FIG. 12 using additional air 210 to form alkaline bicarbonates 190. The first step 1302 is capturing additional air 210 in the form of atmospheric air or concentrated CO₂. The second step 1304 is mixing this CO₂ with the alkaline carbonate stream 100 from the CO₂ removal system to form alkaline bicarbonates 190. The alkaline bicarbonates can be concentrated and stored on land 200 or dispersed in water bodies on land to increase alkalinity levels thereby increasing the CO₂ absorption capacity of the water bodies.

Although the disclosure has been described with reference to certain implementations and embodiments, persons skilled in the art will recognize that changes may be made in form and detail without departing from the spirit and scope of the disclosed apparatus, systems and methods.

What is claimed is:

1. A method for sequestering carbon dioxide (CO₂), comprising:
receiving an alkaline fluid stream comprising carbonate produced by a direct air carbon capture process, the carbonate comprising air-captured CO₂;
receiving an acidic stream produced by the direct air carbon capture process;
producing a PH balanced CO₂ stream by mixing the alkaline fluid stream with an acidic mixing portion comprising 0% up to 100% of the acidic stream; and
storing the pH balanced CO₂ stream in a storage location comprising at least one of a subsurface location, on land, or in a water body;
wherein the storage location and the pH balanced CO₂ stream provide long-term storage of the air-captured CO₂.

2. The method of claim 1, wherein producing the pH balanced CO₂ stream comprises mixing the alkaline fluid stream with the acidic mixing portion in a subsurface chamber.

3. The method of claim 1, wherein producing the PH balanced CO₂ stream comprises mixing the alkaline fluid stream with the acidic mixing portion on the surface.

4. The method of claim 1, wherein producing the pH balanced CO₂ stream comprises simultaneously injecting the alkaline fluid stream and the acidic mixing portion into a subsurface chamber.

5. The method of claim 1, wherein producing the pH balanced CO₂ stream comprises alternately injecting the alkaline fluid stream and the acidic mixing portion into a subsurface chamber.

6. The method of claim 5, further comprising alternately injecting the alkaline fluid stream and the acidic mixing portion in a low geothermal gradient thereby increasing carbonation of mineral rock to expand a mineralization area.

7. The method of claim 1, further comprising injecting the alkaline fluid stream and the acidic mixing portion or the pH balanced CO₂ stream into a subsurface mafic or ultramafic formation.

8. The method of claim 1, further comprising mixing the acidic stream with an alkaline mineral before mixing the alkaline fluid stream with the acidic mixing portion.

9. The method of claim 1, further comprising mixing a nanofiltration sludge produced by the direct air carbon capture process with the alkaline fluid stream, the acidic mixing portion, and an alkaline mineral, wherein the storage location is a water body on land.

10. The method of claim 1, wherein the storage location is a water body on land, and wherein the PH balanced CO₂ stream increases the alkalinity of the water body thereby increasing the carbon capture capacity of the water body.

11. The method of claim 1, further comprising using the acidic stream to degas CO₂ from a water stream, capturing the degassed CO₂ with the alkaline fluid stream, thereby forming a bicarbonate stream, and storing the bicarbonate stream on land or in water.

12. The method of claim 11, further comprising storing the bicarbonate stream in a water body, wherein the bicarbonate stream increases the alkalinity of the water body thereby increasing the carbon capture capacity of the water body.

13. The method of claim 11, further comprising returning the degassed water stream to the sea, wherein the degassed water stream is capable of absorbing additional CO₂ from the atmosphere.

14. The method of claim 13, further comprising mixing the degassed water stream with an alkaline mineral to increase the alkalinity of the degassed water stream before returning the degassed water stream to the sea.

15. A method for sequestering carbon dioxide (CO₂), comprising:
receiving an alkaline fluid stream comprising carbonate produced by a direct air carbon capture process, the carbonate comprising air-captured CO₂;
receiving an acidic stream produced by the direct air carbon capture process;
producing a pH balanced CO₂ stream by mixing the alkaline fluid stream with an acidic mixing portion comprising 0% up to 100% of the acidic stream; and
injecting the alkaline fluid stream and the acidic mixing portion into a subsurface storage location comprising a mafic or ultramafic formation;
wherein the storage location and the pH balanced CO₂ stream provide long-term storage of the air-captured CO₂.

16. The method of claim 15, further comprising mixing the alkaline fluid stream and the acidic mixing portion before injecting into the subsurface storage location.

17. The method of claim 15, further comprising simultaneously injecting and mixing the alkaline fluid stream and the acidic mixing portion into the subsurface storage location to produce the pH balanced CO₂ stream.

18. The method of claim 15, further comprising simultaneously injecting the alkaline fluid stream and the acidic mixing portion at a fluid pressure to create seltzer at the location of the injection or during the injection.

19. The method of claim 15, further comprising dissolving an alkaline material in the acidic stream prior to mixing the alkaline fluid stream with the acidic mixing portion.

20. The method of claim 15, further comprising mixing olivine with the acidic stream to produce an alkaline chloride solution and mixing the alkaline chloride solution with the alkaline fluid stream.
